(19) United States
(12) Patent Application Publication
(10) Pub. No.: US 2014/0267768 A1
(43) Pub. Date: Sep. 18, 2014

(54) Thermographic Camera Accessory for Personal Electronics

(71) Applicant: MU OPTICS, LLC, CHICAGO, IL (US)

(72) Inventors: Abraham Calder Burleigh, Chicago, IL (US); Marc M. Deely, Chicago, IL (US); Charles Patrick McGrath, Chicago, IL (US); John Charles McGrath, Chicago, IL (US)

(21) Appl. No.: 14/212,852

(22) Filed: Mar. 14, 2014

Related U.S. Application Data
(60) Provisional application No. 61/798,407, filed on Mar. 15, 2013.

(51) Int. Cl. G01J 5/02; H04N 5/33

(52) U.S. Cl. CPC G01J 5/025; H04N 5/33; G01J 2005/0077
USPC 348/165; 348/207.1

(57) ABSTRACT

Described herein is a passive infrared image capture device designed to capture, encode, and transmit ambient long-wavelength infrared light as image data to personal electronic devices. Examples of image data can include snapshots and video. Examples of personal electronic devices can include computing devices such as mobile computing devices, personal/desktop computers, laptop computers, etc.

### CROSS-REFERENCE AND PRIORITY CLAIM TO RELATED APPLICATION

This patent application claims priority to U.S. provisional patent application Ser. No. 61/798,407, filed Mar. 15, 2013, entitled “Thermographic Camera Accessory for Personal Electronics”, the entire disclosure of which is incorporated herein by reference.

### INTRODUCTION

Thermography, or the creation of images from Long Wavelength Infrared Radiation (LWIR), allows for the remote detection of an object's temperature at many points. Thermographic imaging allows for the detection of thermal leaks, mechanical stress, electrical faults, and certain illnesses.

Thermographic cameras capture images of objects, such as coolers, heaters, electrical components, machines, buildings, and animals. These images do not record visible light, instead they record thermal blackbody radiation in the range of 7-14 micrometers which is produced by objects and is indicative of the object's temperature. Thermographic images can reveal damaged components or thermal leaks in construction.

Existing thermographic cameras include onboard computational and display hardware, resulting in high retail prices. However, the inventors believe that improvements can be made that would greatly reduce costs while still providing a highly effective thermographic camera. By utilizing a user's existing personal electronics to display and record data produced by the camera, a thermographic imaging device is simplified and it's cost is reduced.

Toward this end, the inventors disclose a thermographic imaging system (hardware) capable of producing, encoding, and relaying thermal images to one or more end user personal electronic devices. The inventor further disclose software on those personal electronic devices specifically made to receive and display the thermographic data on the personal electronic devices' screens.

Described herein is a passive infrared (IR) image capture device (camera) designed to capture, encode, and transmit ambient LWIR as image data to personal electronic devices. Examples of image data can include snapshots and video. Examples of personal electronic devices can include computing devices such as mobile computing devices (e.g., smart phones, tablet computers), personal/desktop computers, laptop computers, etc.

The IR camera does not need to be configured to store or display thermal data itself (other than temporarily in memory buffers for data transmission purposes). Rather, it can be dependent on a linked personal electronic device for storage and display. The thermal data can be sent either wirelessly (e.g., wirelessly over a secure local network) or through a wired communication to a linked personal electronic device.

In an embodiment where a mobile computing device such as a smartphone is used, the thermographic camera can be temporarily attached to the mobile computing device via adhesive, mechanical connection, or magnetic attraction by which the thermographic camera is specifically designed to be attached easily and repeatedly without damage to either device. The transmitted thermal data can comprise raw pixel readings from which temperatures and thermal images can be extrapolated, as well as current device conditions—such as device temperature and battery life—for calibration purposes.

A system component is a thermographic camera. This camera can include an imaging sensor, wherein the sensor is configured to detect LWIR radiation and readout that LWIR radiation data. The camera can also include a LWIR lens to facilitate the detection of thermal radiation by the imaging sensor, circuitry designed to process and encode data from the imaging sensor, and communications circuitry to facilitate the transmission of the encoded thermographic data to the user's personal electronic device(s). Examples of communication circuitry can include wireless communications circuitry and wired communication controllers for connections, such as USB. These components can be contained in a camera body, which is specifically designed to temporarily attach to a personal electronics device, such as a smartphone or other mobile computing device, with a non-damaging adhesive pad or a mechanical connection.

Another system component is software specifically designed to communicate with the thermographic camera and enable output of data from the thermographic camera to the linked personal electronic device.

The disclosed exemplary embodiment differs significantly from existing thermographic imaging devices in that the thermographic camera does not contain its own viewing screen, and is intended specifically for use with, and dependent on a user's existing personal electronics to display and record data produced by the thermographic camera.

These and other features and advantages of the present invention will be apparent to those having ordinary skill in the art upon review of the teachings in the following description and drawings.

### BRIEF DESCRIPTION OF THE DRAWINGS

The accompanying drawings, which are incorporated in and form a part of the specification, illustrate example embodiments of the present invention and together with the description, serve to explain the principles of the invention. In the drawings:

FIG. 1 illustrates a conceptual view of a thermographic camera's functionality and components;

FIG. 2 illustrates an external view of an exploded thermographic camera;

FIG. 3 illustrates a representation of a thermographic camera adhered to an personal electronic device;

FIG. 4 illustrates a representation of a “Blending Mode”;

FIG. 5 illustrates a representation of a “Point Mode”; and

FIG. 6 illustrates a representation of a “Window Mode”.

### DETAILED DESCRIPTION OF THE PREFERRED EMBODIMENT

Described in FIG. 1 is the general functionality of an IR camera and its relation to an personal electronic device as well as the interaction of supplied software.

Referring to FIGS. 1-2, the IR camera 1 may be attached as shown in FIG. 3 to an personal electronic device 11 supplied by the user by either adhesive polymer 10, mechanical means, or magnetic attraction. This attachment is to be temporary and non-detrimental to either camera 1 or device 11.

The personal electronic device 11 may comprise a WiFi receiver 15, a device camera 16, a display 14, a processor 12, and a user interface 13. The user interface 13 may receive user input and control operations of the thermographic camera 1 in response to received user input.

Incident LWIR Light is focused and collimated by an optic 7 upon an IR sensor 6—such as a microbolometer—whereupon an analog signal is produced giving a voltage proportional to the wavelength of the incident radiation at each pixel upon the IR sensor's surface. The LWIR radiation may be focused by either refractive or reflective optics. The measured wavelengths are proportional to the temperature of an object or objects within a field of view of the optic 7. An example of an IR sensor 6 that can be used is an uncooled microbolometer IR sensor available from Mikrosens. IR sensors from ULIS-IR could also be used.

The analog signal produced by the IR sensor 6 is then converted by a readout integrated circuit (ROIC) 8 into a digital video signal. The ROIC 8 is configured to digitally encode raw sensor readings, and the ROIC 8 may further encode the raw sensor readings with metadata. The digital video signal is transmitted over a network provided either by a USB connection or a wireless connection (e.g., a WiFi transmitter 5 to the personal electronic device 11. The digital video signal transmitted to the personal electronic device 11 may be presented to the personal electronic device 11 in a functional format. The wireless transmitter 5 may transmit data according to the 802.11 wireless standard. The network connection between the camera 1 and the personal electronic device 11 may be a secure local network.

In an example embodiment, the thermographic camera 1 does not include a processor that is configured to generate a thermal image from raw thermal data detected by the sensor 6. Instead, the processor 12 on the personal electronic device 11 can be used to generate a thermal image from the raw thermal data transmitted from the camera 1 to the personal electronic device 11.

Power is supplied to the sensor 6 and the WiFi transmitter 5 by a rechargeable power supply 3. Power and data are communicated between devices by an integrated circuit (IC) 2, which also houses a power supply adapter 4 to facilitate charging as well as the ability for USB connection.

Supplied software allows the personal electronic device 11 to process the transmitted video data and display the data to the user. The software may resolve and analyze video on any major operating systems, such as, but not limited to, Apple iOS, Google Android, Apple OS X, various Linux distributions, and Microsoft Windows platform. In the presence of a video camera on the personal electronic device 11, the supplied software provides the user with options such as, but not limited to, a “Blending Mode” as shown in FIG. 4, a “Point Mode” as shown in FIG. 5, and a “Window Mode” as shown in FIG. 6. The “Blending Mode” illustrated in FIG. 4 is configured to blend thermographic images from the thermographic camera 1 with images taken from an personal electronic device's 11 onboard visible camera 16 or other imaging sensor. The “Point Mode” illustrated in FIG. 5 is configured to display detailed data of user chosen pixels of thermographic images from the thermographic camera 1 upon being touched by the user. Operation of the software can display temperature data specific to a user specified pixel. And, the “Window Mode” illustrated in FIG. 6 is configured to overlay thermographic images from the thermographic camera 1 on top of images taken from the personal electronic device's 11 onboard visible camera 16 or other imaging sensor, and thermographic images are able to be cropped in relation to visible images. The software may further be configured to visually represent LWIR scene data using color gradients in the visible spectrum.

The software may further be configured to store all or portions of the digital video signal as video or still frames. The software may also transmit stored data received from the thermographic camera 1 using the electronic device's existing communication equipment.

Further still, the software may correct parallax error from misalignment of the optical axis of the linked device's visible camera by image analysis.

Referring to FIG. 2, the thermographic camera 1 comprises the thermographic camera's body 1a, the IC board 2, the rechargeable power supply 3, the power supply adapter 4, the WiFi transmitter 5, the LWIR sensor 6, the focusing optic 7, the sensor ROIC 8, a camera backing 9, and the adhesive 10 for attaching to the person electronic device 11.

Thermal drift over large ranges in the perceived IR scene or the thermographic camera circuitry itself can induce additional noise in the IR video signal, which requires a recalibration of the device. Calibration is accomplished by covering the IR sensor's 6 field of view by a thermally “cold” surface, such as glass or aluminum. When the software detects significant change it will prompt the user to calibrate the thermographic camera 1, this is accomplished by attaching a lens cap containing a thermally “cold” material sheet upon the thermographic camera 1 whereupon the IR sensor 6 obtains a dark reading with no incident IR radiation. This reading is used to calibrate the individual sensor pixels and restore video quality.

While the present invention has been described above in relation to exemplary embodiments, various modifications may be made thereto that still fall within the invention's scope, as would be recognized by those of ordinary skill in the art. Such modifications to the invention will be recognizable upon review of the teachings herein. As such, the full scope of the present invention is to be defined solely by the appended claims and their legal equivalents.

What is claimed is:

1. An apparatus comprising:
a personal electronic device; and
a thermographic camera for communication with the personal electronic device;
wherein the thermographic camera is configured to capture raw thermal data for an area of interest and communicate the raw thermal data to the personal electronic device; and
wherein the personal electronic device is configured to receive and process the raw thermal data to generate a thermal image.

2. The apparatus of claim 1, wherein the personal electronic device is further configured to display the generated thermal image.

3. The apparatus of claim 1, wherein the thermographic camera comprises an LWIR radiation imaging sensor.

4. The apparatus of claim 1, wherein the thermographic camera does not include a processor that is configured to generate a thermal image from raw thermal data detected by the sensor.

5. The apparatus of claim 1, wherein the thermographic camera is configured for detachable attachment to the personal electronic device.

6. The apparatus of claim 5, wherein the thermographic camera is configured for detachable attachment to an external surface of the personal electronic device via a member of the group consisting of (1) an adhesive, (2) a mechanical connection, and (3) a magnetic attraction.

7. The apparatus of claim 1, wherein the thermographic camera is further configured to wirelessly communicate the thermal data to the personal electronic device.

8. The apparatus of claim 1, wherein the thermographic camera is further configured to communicate the thermal data to the personal electronic device via a wired connection.

9. The apparatus of claim 1, wherein the personal electronic device comprises a user interface, and wherein the personal electronic device is further configured to receive user input through the user interface and control operation of the thermographic camera in response to the received user input.

10. The apparatus of claim 1, wherein the personal electronic device comprises a mobile computing device.

11. The apparatus of claim 10, wherein the mobile computing device comprises a smart phone.

12. The apparatus of claim 10, wherein the mobile computing device comprises a tablet computer.

13. The apparatus of claim 1, wherein the personal computing device comprises at least one member of the group consisting of a laptop computer and a desktop computer.

14. The apparatus of claim 1, wherein the thermographic camera comprises an onboard, rechargeable battery for powering an LWIR sensor and a transmitter.

15. A thermographic camera accessory for communication with a personal electronic device, the thermographic camera accessory comprising:
an infrared (IR) sensor;
a focusing optic configured to focus ambient IR from a thermal source on the IR sensor;
a read circuit configured to digitize raw IR data from the sensor, the digitized raw IR data being indicative of a thermal property of the thermal source; and
a communication circuit configured to communicate the digitized IR data to an external personal electronic device; and
wherein the thermographic camera accessory does not include a processor that is configured to generate a thermal image from raw IR data detected by the IR sensor.

16. The thermographic camera accessory of claim 15, wherein the thermographic camera accessory further comprises a member of the group consisting of (1) an adhesive, (2) a mechanical component, and (3) a magnetic component, the member configured to permit detachable attachment of the thermographic camera accessory to the external personal electronic device.

17. A method for capturing and transmitting infrared scenes to a personal electronic device, the method comprising:
temporarily attaching a thermographic camera to the personal electronic device;
focusing ambient long-wavelength infrared light (LWIR) radiation onto an LWIR sensing device within the thermographic camera; and
transmitting, by a transmitter, sensor data from the LWIR sensing device over a network to the personal electronic device.

18. The method of claim 17, further comprising:
digitally encoding, by a readout integrated circuit within the thermographic camera, raw sensor data output by the LWIR sensing device.

19. The method of claim 18, wherein the sensor data is encoded as digital video with meta-data.

20. The method of claim 17, wherein attaching the thermographic camera to the personal electronic device comprises creating a temporary bond between the imaging device and the personal electronic device.

21. The method of claim 20, wherein the temporary bond is formed by adhesive, a detachable mechanical connection, or a magnetic connection.

22. The method of claim 17, wherein transmitting the sensor data from the LWIR sensing device over the network to the personal electronic device comprises transmitting the sensor readings over a wireless network or a USB connection.

23. The method of claim 17, wherein the sensor data is presented to the personal electronic device in a functional format.

24. The method of claim 17, wherein the LWIR radiation is focused by refractive optics.

25. The method of claim 17, wherein the LWIR radiation is focused by reflective optics.

26. The method of claim 17, wherein the LWIR radiation is collimated onto the LWIR sensing device.

27. The method of claim 17, wherein the temporarily attaching step comprises temporarily attaching the thermographic camera to an external surface of the personal electronic device.

28. A method for displaying infrared scenes by a personal electronic device comprising
temporarily attaching an external thermographic camera to the personal electronic device;
receiving, by a processor on the personal electronic device, sensor data from the thermographic camera over a network;
processing, by the processor on the personal electronic device, the sensor data to generate a thermographic image; and
displaying, by the processor on the personal electronics device, the thermographic image to a user through a display device on the personal electronics device.

29. The method of claim 28, further comprising
overlaying, by the processor on the personal electronic device, the received sensor data on standard video captured by a camera connected to the personal electronic device.

30. The method of claim 28, further comprising
displaying, by the processor on the personal electronic device, temperature data specific to a user specified pixel based on the received sensor data.

31. The method claim 28, further comprising
visually representing, by the processor on the personal electronic device, the sensor data using color gradients in the visible spectrum.

32. The method of claim 28, further comprising
storing, by the processor on the personal electronic device, portions of the video stream as video or still frames.

33. The method of claim 32, further comprising
transmitting, by the processor on the personal electronic device, the stored data by means of the personal electronic device's existing communication equipment.

34. The method of claim 28, further comprising
correcting, by the processor on the personal electronic device, parallax error from misalignment of the optical axis of the linked device's visible camera by image analysis.
